(19) United States
(12) Patent Application Publication
(10) Pub. No.: US 2011/0147321 A1
(43) Pub. Date: Jun. 23, 2011

(54) FILTER WITH ADJUSTABLE POROSITY

(76) Inventor: Nir Oz, Misgav (IL)

(21) Appl. No.: 13/060,541

(22) PCT Filed: Aug. 10, 2009
(86) PCT No.: PCT/IL09/00777

§ 371 Date: Feb. 24, 2011

Related U.S. Application Data
(60) Provisional application No. 61/136,351, filed on Aug. 29, 2008.

(51) Int. Cl. B01D 24/10; B01D 46/30; B01D 46/42; B01D 24/46

(52) U.S. Cl. 210/793; 55/475; 210/287; 95/274; 210/807; 210/792; 95/276

(57) ABSTRACT

A filter includes a filter chamber of adjustable volume. The filter chamber encloses a compactable filter medium through which fluid to be filtered may flow. The filter medium includes a plurality of filter particles. A filter particle has an initial shape and is deformable upon application of a deforming force, being capable of substantially regaining its initial shape upon removal of the deforming force. The porosity of the filter medium is adjustable by adjusting the volume of the filter chamber so as adjust the compaction of the filter medium.

### FIELD OF THE INVENTION

The present invention relates to filters. More particularly, the present invention relates to a filter with adjustable porosity.

### BACKGROUND OF THE INVENTION

Filters are used in many applications where suspended particulate impurities are to be removed from a fluid, such as a liquid or a gas. For example, a filter may be used to remove impurities from a fluid that is to be utilized, for example as a fuel, as a component of an industrial process, in agriculture, or for human or animal consumption, or from a waste fluid prior to disposal.

Generally, a filter includes a filter material that is enclosed in a framework or enclosure. A fluid to be filtered is directed through an opening in the enclosure, through the filter material, and out of the enclosure through another opening. A typical filter material includes a solid material with pores, such as openings or voids, through which the fluid to be filtered may be induced to flow. The size of the pores is generally matched to the size of the solid particles to be removed from the fluid. Thus, a fluid to be filtered may pass through the filter material while suspended solid particles are trapped in the pores of filter material. Generally, a given filter material is designed to filter suspended particles whose sizes fall within a particular range of sizes. In order to adapt the filter for filtering suspended particles of a different size range, the filter material is replaced, or a different filter is used.

Filter materials may include a substantially homogenous porous object, such as an object sponge, gauze, cloth, paper, or porous ceramic. Alternatively, a filter material may include a strainer or sieve in which a material is manufactured with holes or openings. Alternatively, the filter material may include a collection of granular or particulate material held in a container. The pores in a granular filter material are created by the spaces between the individual granules. Such granular materials may include, for example, sand, gravel, pebbles, or manufactured particles of a man-made or natural material such as glass, charcoal, wood, ceramic, or plastic. Filter devices have been described which include containers for containing a filter material in the form of a collection of balls, lumps, or granules. Such devices are described by, for example, Philip et al. (FR 2870466), Hard (US 2003/042213), and Kojicic, deceased et al. (U.S. Pat. No. 4,649,996).

Filter devices have been described in which the particle size filtered by the filter material may vary. For example, Lederman in WO 0043097 describes a filter in which granular filter media is stratified, with the size of the granules, and thus the porosity, decreasing from bottom to top. Thus, when a fluid flows upward through the filter, coarser particles are removed by the lower layers and finer particles by the upper layers.

A filter material may be compressible. For example, a filter material may include strands or fibers. When filter material is compressible, generally the porosity of the compressible material may be reduced by compressing the material. Decreasing the porosity typically correlates with smaller pore size in the material, and the trapping of smaller particles. For example, Dew in US 2008/0257805 describes a filtration system in which a fibrous lump filtration medium is compressed so as to attain a desired porosity. The compression is reduced when the filtration medium is to be cleaned with the assistance of compressed air flowing through the fluid. Various configurations of systems with compressed fibrous lump filter materials, or of compressed sponge, foam, or fiber filter materials, are also described by Masuda et al. (U.S. Pat. No. 5,248,415), Wang (CN 1475292), Ding (CN 101066511), Suzuki et al. (JP 63093312), Schreiber et al. (DE 19738067), Kobayashi et al. (JP 2002/058916), and Makino (JP 58109109). With a non-elastic fibrous material, compression may not be reversible. For example, the material may exhibit hysteresis in that removing a compression force may not necessarily result in the material reversibly expanding so as to increase the porosity.

When a filter is used to filter solid particles from a fluid, the particles, typically, become trapped in the pores of the filter material. Thus, continued use of the filter may lead to clogging of a significant portion of the pores. Such clogging of the pores may impede the flow of the fluid through the filter. Therefore, a typical filter may be flushed occasionally in order to remove particles from the pores of the filter. For example, fluid may be made to flow through the filter along a different path than during filtering so as to cause the particles to detach from the pores of the filter and flow to a waste receptacle. Typically, washing is performed by backwashing, during which the direction of fluid flow through the filter is the reverse of the flow during filtering. Due to the large surface area and complex structure of the surface of a fibrous, spongy, or foamy material, such materials may be difficult to clean by backwashing or flushing. Tadokoro (JP 6079108) describes a filter in which granular matter is mixed with a fibrous lump filter medium. The granular matter is described as facilitating cleaning of the fibrous lumps during backwashing.

Xie in U.S. Pat. No. 6,969,469 describes a crumb rubber filter medium that is compressible. When placed into a vertical filter container, a crumb rubber particle is compressed by the weight the particles above it. Thus, particles situated lower in the container are compressed more than those above them. Thus, the porosity of the filter decreases from the top of the filter to the bottom. Since the particles are compressed by the weight of other particles in the stack, it is not possible to reduce the compression by increasing the volume of the container.

It is an object of the present invention to provide a filter with a compactable filter medium including reversibly deformable homogeneous particles, where the particles are easily cleanable by a backwashing procedure, and where adjusting the volume reversibly adjusts the porosity of the filter medium.

Other aims and advantages of the present invention will become apparent after reading the present invention and reviewing the accompanying drawings.

### SUMMARY OF THE INVENTION

There is thus provided, in accordance with some embodiments of the present invention, a filter that includes a filter chamber of adjustable volume. The filter chamber encloses a compactable filter medium through which fluid to be filtered may flow. The filter medium includes a plurality of filter particles, a particle of which has an initial shape which is deformable upon application of a deforming force and being capable of substantially regaining its initial shape upon removal of the deforming force. The porosity of the filter medium is adjustable by adjusting the volume of the filter chamber so as to obtain a desired porosity of the filter medium.

Furthermore, in accordance with some embodiments of the present invention, a particle of said plurality of filter particles comprises a thermosetic polymer.

Furthermore, in accordance with some embodiments of the present invention, a particle of said plurality of filter particles comprises a homogeneous outer surface.

Furthermore, in accordance with some embodiments of the present invention, a particle of said plurality of filter particles comprises a material selected from the group of materials consisting of: natural rubber, synthetic rubber, plastic, fluoroelastomer and silicone.

Furthermore, in accordance with some embodiments of the present invention, the shape of a particle of said plurality of filter particles is selected from the group of shapes consisting of: spherical, spheroid, cylindrical, polyhedral, convex-polyhedral or concave-polyhedral.

Furthermore, in accordance with some embodiments of the present invention, a particle of said plurality of filter particles comprises a material that repels the fluid or contamination particles therein.

Furthermore, in accordance with some embodiments of the present invention, the filter medium comprises cascaded layers.

Furthermore, in accordance with some embodiments of the present invention, the chamber comprises two openings, one opening serving as a flow inlet and one opening serving as a flow outlet.

Furthermore, in accordance with some embodiments of the present invention, an opening of said two openings comprises a perforated wall.

Furthermore, in accordance with some embodiments of the present invention, the diameter of a particle of said plurality of filter particles is in the range of 0.5 mm to 30 mm.

Furthermore, in accordance with some embodiments of the present invention, the diameter of a particle of said plurality of filter particles is in the range of 1 mm to 10 mm.

Furthermore, in accordance with some embodiments of the present invention, the hardness of a particle of said plurality of filter particles is in the range of 20 to 80 in the “A” scale of Shore hardness test.

Furthermore, in accordance with some embodiments of the present invention, there is provided a filtering method that includes providing a filter, which includes a filter chamber of adjustable volume. The filter chamber encloses a compactable filter medium through which fluid to be filtered may flow. The filter medium includes a plurality of filter particles, a particle of which has an initial shape, which is deformable upon application of a deforming force and being capable of substantially regaining its initial shape upon removal of the deforming force. The method further includes obtaining a desired porosity of the filter medium being by adjusting the volume of the filter chamber so as to obtain a desired porosity of the filter medium, and causing a fluid to be filtered to flow through the filter medium.

Furthermore, in accordance with some embodiments of the present invention, the method includes expanding the volume of the filter chamber so that said particle of said plurality of particles regains its initial shape, and causing a washing fluid to flow through the filter medium and remove contamination particles from the filter medium.

Furthermore, in accordance with some embodiments of the present invention, the step of causing a washing fluid to flow through the filter medium includes causing the washing fluid to flow in a direction that is opposite to the flow direction during filtering.

### BRIEF DESCRIPTION OF THE DRAWINGS

In order to better understand the present invention, and appreciate its practical applications, the following Figures are provided and referenced hereafter. It should be noted that the Figures are given as examples only and in no way limit the scope of the invention. Like components are denoted by like reference numerals.

FIG. 1 illustrates a filter with a compactable filter medium in a filtration configuration, in accordance with embodiments of the present invention.

FIG. 2 illustrates backwashing of a compactable filter medium in accordance with embodiments of the present invention.

### DETAILED DESCRIPTION OF EMBODIMENTS

In the following detailed description, numerous specific details are set forth in order to provide a thorough understanding of the invention. However, it will be understood by those of ordinary skill in the art that the invention may be practiced without these specific details. In other instances, well-known methods, procedures, components, modules, units and/or circuits have not been described in detail so as not to obscure the invention.

A filter, in accordance with embodiments of the present invention, includes a filter chamber having an adjustable volume. The filter chamber encloses a compactable elastic filter medium that includes a collection of deformable elastic filter particles. A fluid to be filtered may enter the filter through a filtering inlet. At least one wall of the filter chamber includes perforations, holes, a window, port, mesh, or other form of opening that enable fluid to be filtered to enter the filter chamber. The opening is designed such that a fluid to be filtered may flow through the opening, while the filter particles are retained inside the chamber. Fluid may exit from the filter through a filtering outlet. The filter is configured such that fluid flowing into the filtering inlet to the filtering outlet must pass through the filter medium in the filter chamber.

The compactable filter medium includes filter particles made of a deformable elastic material. A filter particle has an initial shape, such as, for example spherical, spheroid, cylindrical, polyhedral, convex-polyhedral or concave-polyhedral. Other shapes, including amorphous shapes, may be applicable too. A cylindrical particle, with a circle or a polygonal cross-section, may be preferred when considering manufacturing by extrusion.

Typically, a filter particle, or at least its outer surface, is impermeable to a fluid to be filtered. A filter particle typically presents a homogeneous outer surface (without externally noticeable fibrous or porous structure). The substantially homogeneous structure results in a surface area that is small relative to a similarly sized fibrous lump or structure. A filter particle may typically be made of rubber (synthetic or natural), plastic, silicone, fluoroelastomer or any other deformable elastic material. Typically, the material is thermosetic. The elastic material is substantially reversibly deformable by a deforming force, such that the filter particle is substantially regains its original shape when the deforming force is removed. The selection of the particle material may be determined on the basis of the characteristics of the fluid to be filtered. For example, the particle material may be selected such that the particles do not react with a fluid to be filtered, or that the properties of the particle do not change when in contact with a fluid to be filtered.

The filter particles forming the filter medium may be of uniform size and composition. For example, for many purposes particle diameter may range from 0.5 millimeters (mm) to 30 mm. In a typical filter configuration such as for water filtering, water reclamation, water desalination and waste water treatment, particle diameter may be in the range 1 mm to 10 mm. A typical hardness value may be in the range of 20 to 80 in the “A” scale of the Shore hardness test according to ASTM D2240). A typical elasticity value for tensile may be in the range of 0 to 700% and for compression may be in the range of 0 to 65%. Alternatively, the properties of the filter particles may vary from particle to particle with respect to size, shape, density, mass, hardness, elasticity, electrical or thermal conductivity, magnetic or electrostatic properties, surface properties, or composition. Filter particles with varying properties may be organized into layers of varying properties by means of intentional layering, with or without the use of partitions. Filter particles with varying properties may vertically self-organize into layers when agitated and allowed to settle.

At least one wall of the filter chamber, or a portion of at least one wall of the filter chamber, is movable. Moving the movable wall of the filter chamber may increase or decrease the volume of the chamber. Alternatively, the volume of the filter chamber may be adjustable in another manner, for example, by expansion of an internal structure, such as a balloon. When the volume is decreased, the walls of the chamber may apply a compacting force that tends to compact the filter medium. Applying a compacting force to the filter medium may deform the filter particles such that the packing of the filter particles becomes more compact Typically, as the filter medium is compacted, the spaces between filter particles become smaller, thus decreasing the porosity of the filter medium. On the other hand, when the volume of the chamber is increased, the compacting force is reduced. When the compacting force is reduced, the elasticity of a particle may tend to reduce the deformation of the particle, thus increasing the spaces between the particles and the porosity of the filter medium.

When a fluid flows through the filter medium in the filter chamber, fluid typically passes though the spaces between the filter particles. A contaminant in the form of a contamination particle that is suspended in the fluid may be trapped in a space between the filter particles. Due to the substantially homogenous structure of the filter particles and the filter particle surfaces, a typical fluid or contamination particle does not adhere, nor is it absorbed or adsorbed by, a filter particle or its surface. A typical size of the spaces between the filter particles may thus determine the fineness or coarseness of contamination particles that may be trapped by the filter medium. Moving a movable wall of the filter chamber inward, or otherwise reducing the volume of the filter chamber, may increase the compaction of the filter medium. A high degree of compaction of the filter medium may reduce the porosity of the filter medium in the filter chamber. Depending on the configuration of the chamber and the properties of the filter particles, the porosity may be reduced, for example, to a value close to zero. When the porosity is close to zero, the filter medium may trap almost all suspended contamination particles, and may impede the flow of the fluid itself through the filter chamber.

On the other hand, the movable wall of the filter chamber may be moved outward, or the volume of the filter chamber otherwise increased. Increasing the volume of the chamber may decrease the compaction of the filter medium. For example, the compaction of the filter medium may be reduced until the elasticity of a filter particle restores the particle substantially to its initial shape prior to deformation, and the filter medium to its non-compacted volume. Further expansion of the volume of the filter chamber may then enable the filter particles to freely separate from one another under the force of, for example, a fluid flowing through the filter medium. For example, the filter chamber may be expanded to such as state when a washing fluid is passed through the filter chamber in order to remove any trapped contamination particles.

The elasticity of the filter particles may enable the filter particles to return substantially to their initial shapes in a substantially repeatable manner when a compacting force is removed. Thus, the elasticity of the filter particles may enable reversible and repeatable adjustment of the porosity of the filter medium by adjusting the volume of the filter chamber. Thus, the filter and filter chamber may be calibrated such that a given chamber volume is associated with a given filter porosity and with given filtering fineness.

A filter in accordance with embodiments of the present invention may have two typical configurations. In a filtering configuration, the volume of the filter chamber is decreased so as to decrease the porosity of the filter medium. Typically, the porosity is adjusted in accordance with the properties of the fluid to be filtered, and a typical size of a contamination particle to be removed by the filter. Fluid to be filtered may flow into the filter through a filtering inlet. The fluid then passes through the filter chamber, where the fluid is filtered and contamination particles may be removed by the filter medium. The filtered fluid may then flow out of the filter through a filtering outlet. In the event that several size ranges of contamination particles are to be removed, several filters, or several filter media with differing porosities, may be cascaded. With cascaded filter chambers, the fluid typically flows through a series of filter chambers, each chamber having a filter medium with porosity smaller than that of the medium in the previous chamber. Alternatively, a single filter chamber may contain a layered filter medium, where each layer may have a different level of porosity which is determined by the size, elasticity, shape or other properties of the filter medium.

The filter may also be configurable in a washing configuration. In the washing configuration, the volume of the filter chamber is increased such that the porosity of the filter medium is greatly increased. In this configuration, the elasticity of the filter particles may have substantially restored the filter particles to their shapes prior to deformation. In this configuration, the trapped contamination particles are released and a fluid that flows through the filter medium, removes the released contamination particles from the spaces between the filter particles washing them away. A washing fluid may flow in a direction that is opposite to the flow direction during filtering, or in the direction of filtering flow.

When the volume of the filter medium is increased and the spaces between the particles become greater, dirt and contamination particles that have accumulated in these spaces and which do not stick to the particles are released and become afloat. This feature renders the washing of the filter medium very easy and requires less washing fluid than in other common filtering media. Typically the minimal volume of washing liquid required to wash the filter medium is in the same order of the volume of the filter medium, whereas in other common filtering devices the volume of washing liquid required is much greater than the volume of the filter medium. Thus the energy input in washing the filter medium of embodiments of the present invention is substantially smaller than in other typical filters.

Typically, a washing fluid may flow into the filter through a washing inlet. Typically, the washing inlet may be located near the filtering outlet. A washing outlet may be located on another side of the filter chamber such that a washing fluid may flow from the washing inlet to the washing outlet through the filter chamber. Therefore, the washing outlet may be typically located near the filtering inlet. Typically, the direction of flow of washing fluid through the filter chamber is opposite the direction of flow of fluid through the filter chamber in a filtering configuration. The washing fluid flowing through the filter chamber may remove trapped contamination particles from between, and from the surfaces of, the filter particles. The washing fluid may carry the removed contamination particles out of the filter through the washing outlet, and into an appropriate receptacle. Typically, the path of the washing fluid is to be kept separate from the path of fluid being filtered. For example, the washing fluid may be prevented from contaminating the filtered fluid, or the fluid to be filtered may be prevented from contaminating the washing fluid. Therefore, the filtering inlet and outlet may be closed when the washing inlet and outlet are open, and vice versa.

Reference is now made to the accompanying Figures.

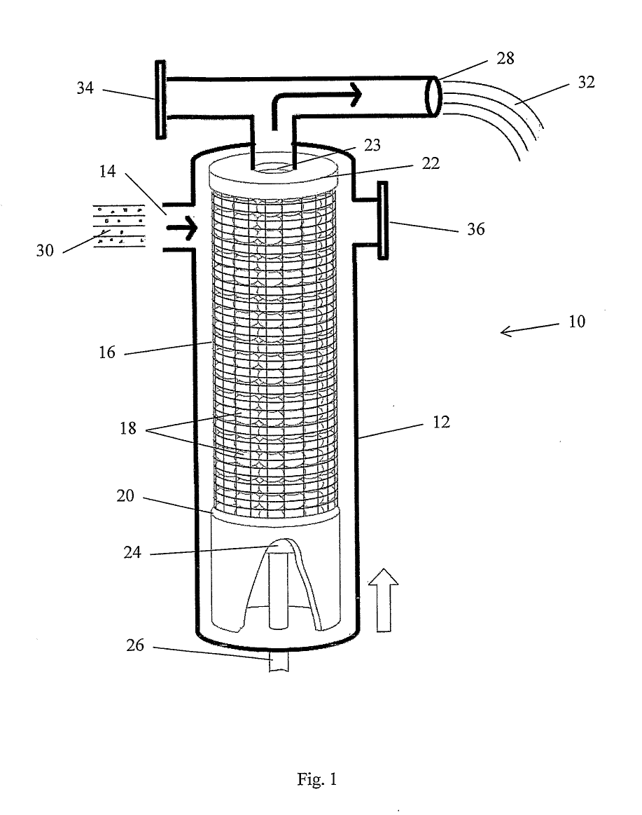

FIG. 1 illustrates a filter with a compactable filter medium in a filtration configuration, in accordance with embodiments of the present invention. A typical filter apparatus 10 is shown in a filtering configuration. Fluid tank 12 of filter apparatus 10 encloses filter chamber 20. Although fluid tank 12 and filter chamber 20 are shown as vertical cylinders, the shape of the fluid tank, the filter chamber, or both, may be in any form suitable to a given configuration or application. Other suitable forms may include, for example, a horizontally or obliquely oriented cylinder, or an alternative shape. Other possible shapes may include, for example, a box with approximately rectangular sides, or a toroid with circular, elliptical, or polygonal cross section.

Filter chamber 20 encloses a filter medium that includes deformed filter particles 18. As shown in FIG. 1, filter particles 18 are in their compacted, deformed state. When in its natural, not deformed state, the filter particles 18 is, as an example, spherical. Therefore, deformed filter particles 18 may be in the form of deformed spheres such as dented, convex or an oblate spheroid. Deformed filter particles 18 may be uniform in size and properties, or may include particles with a range of shapes, sizes, densities, hardness and elasticity or other properties. Deformed filter particles 18 are confined in filter chamber 20 by one or more perforated walls, such as perforated wall 16. Perforated wall includes openings in a perforated or mesh-like structure. The openings are configured such that fluid may freely flow through the openings while filter particles 18 cannot. For example, the openings may be smaller than the minimum size of a particle of deformed filter particles 18. Although perforated wall 16 is shown as cylindrical, the perforated wall may be of any suitable shape. In particular, a perforated section or window in an otherwise closed wall, either stationary or movable, may serve as the perforated wall.

Deformed filter particles 18 are also confined in filter chamber 20 by one or more stationary walls, such as stationary wall 22, and by at least one movable wall, such as movable wall 24. Stationary wall 22 and movable wall 24 are shown as circular disks, although they may be of any suitable shape. As shown, stationary wall 22 includes a fluid port 23. Fluid port 23 is situated such that fluid entering filter chamber 20 through perforated wall 16 must exit through fluid port 23, and vice versa. In alternative embodiments of the present invention the filter volume may be changed using an inflatable balloon or similar device that applies controllable pressure on the filter medium compacting it or increasing it as desired.

Alternatively, to perforated wall 16 and fluid port 23, openings in the filter chamber may be positioned in an alternative manner. Openings are positioned such that a fluid that enters the chamber through one opening is channeled so as to traverse a portion of the filter medium before exiting through another opening. For example, suitable openings for entry and exit of fluid may be provided on opposite sides of a filter chamber, on different walls of the chamber, or on a single wall of the chamber. The filter chamber may be appropriately shaped, or may be provided with internal structure, such as walls, partitions, or baffles, to channel the fluid through a sufficient portion of the filter medium.

Movable wall 24 may be moved inward or outward by a force provided by a suitable mechanism, such as, for example, piston 26. A force on piston 26 may be provided by a suitable mechanism, as known in the art. For example, a powered motor or hand-operated crank may operate a suitable transmission mechanism in order to provide an inward or outward force on piston 26. An inward force applied to movable wall 24 via piston 26 may provide a compacting force that maintains deformed filter particles 18 in a compacted state. Alternatively, the volume adjustment mechanism may include several movable walls that may be moved inward or outward.

A fluid to be filtered, such as an impure fluid 30 with suspended contamination particles, enters tank 12 of filter 10 through filtering inlet 14. When in a filtering configuration, impure fluid 30 flows from tank 12 through perforated wall 16 into filter chamber 20. For example, impure fluid 30 may be pressurized at filtering inlet 14 so as to drive the flow of impure fluid 30 through filter 10 and filter chamber 20. Fluid entering filter chamber 20 passes through a filter medium that includes deformed filter particles 18. As impure fluid 30 passes between deformed filter particles 18, the fluid is filtered and contamination particles may be removed from the fluid. The flow of the filtered fluid is confined such that the filtered fluid may exit filter chamber 20 through one or more ports, such as port 23 in stationary wall 22. Port 23 is situated such that fluid flowing from perforated wall 16 to port 23 must traverse a sufficient distance between deformed filter particles 18 to remove a desired amount of contamination particles from the fluid. Filtered fluid 32 that flows out of filter chamber 20 through port 23 may then flow out of tank 12 of filter apparatus 10 through filtering outlet 28. Filtered fluid 32 flowing out of filtering outlet 28 may be directed to a destination to where filtered fluid 32 is to be utilized, stored, or disposed of. Alternatively, filtered fluid 32 may be directed to a filtering inlet 14 of another filter or processing for further filtering or processing.

Alternatively to filtering inlet 14 and filtering outlet 28, suitable fluid inlets and outlets may be configured in an alternative manner. For example, an inlet and outlet may be located on opposite sides of a filter, on different walls of the filter, or on the same wall. The filter may be provided with internal structure to ensure that fluid that flows from the inlet to the outlet is channeled through suitable openings of the filter chamber.

A compacting force applied to piston 26 may be adjusted to filter a specific range of sizes of contamination particles. For example, a particular configuration of filter apparatus 10 and of filter particles 18 may be subject to a calibration procedure. During such a calibration procedure, for example, a given applied compacting force may be associated with filtering of a particular size of suspended contamination particles of a particular composition from a fluid of particular composition.

As contamination particles are removed from the fluid, the contamination particles may accumulate in spaces between deformed filter particles 18. As contamination particles accumulate in the spaces, the spaces may become clogged, impeding the passage of fluid through the spaces. When the spaces become clogged, filter apparatus filter chamber 20 or filter particles 18 may be replaced. Alternatively, accumulated contamination particles in the spaces between filter particles 18 may be removed. Using a filter according to embodiments of the present invention may eliminate the need to use chemical (which are typically used for releasing the contamination particles from the filtering particles or for consolidating small contamination particles into bigger agglomerated contamination particles) and is thus more environmental-friendly. For example, a cleaning or washing fluid flowing through filter chamber 20 may remove the accumulated contamination particles. For example, backwashing, in which a washing fluid flows in a direction substantially opposite the direction of flow of a fluid being filtered, may be employed to remove accumulated contamination particles.

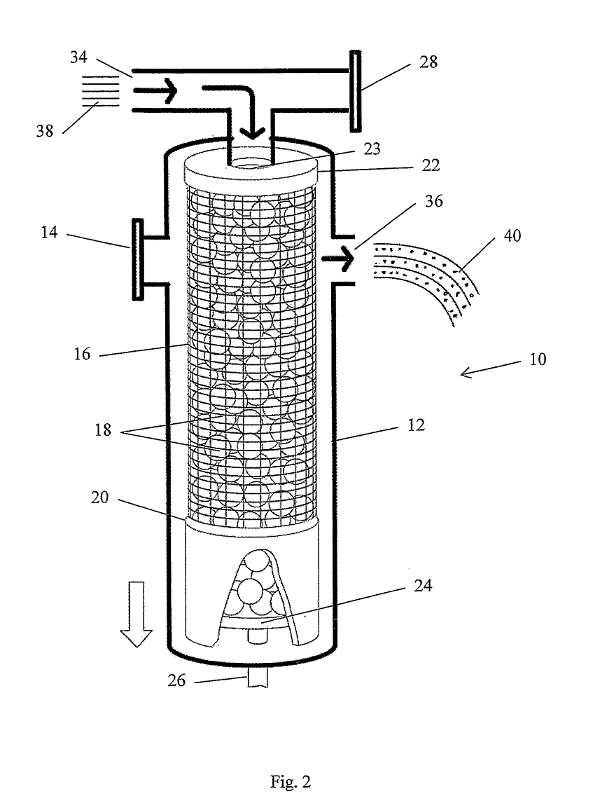

FIG. 2 illustrates backwashing of a compactable filter medium in accordance with embodiments of the present invention. As illustrated in FIG. 2, filter apparatus 10 is in a backwashing configuration. Piston 26 and attached movable wall 24 have been retracted, removing compacting pressure from filter particles 18. When the compacting pressure is removed, the elasticity of filter particles 18 causes filter particles 18 to expand substantially to their initial, non-deformed state. In the example shown, the shape of expanded filter particles 18 is spherical. Further retraction of movable wall 24 may further expand the volume of filter chamber 20. Further expansion may provide room for expanded filter particles 18 to separate from one another when urged to do so, for example, by the flow of a fluid through filter chamber 20.

During backwashing of filter chamber 20, washing fluid 38, from a reservoir or other source of washing fluid, flows into filter apparatus 10 through washing inlet 34. When in a backwashing configuration, filtering outlet 28 is closed. Washing fluid 38 flows into filter chamber 20 through port 23, between expanded filter particles 18, and out of filter chamber 20 through perforated wall 16. During backwashing, the direction of flow of washing fluid 38 through filter chamber 20 is the opposite of the direction of fluid flow during a filtering (FIG. 1).

As a result of the retraction of movable wall 24, washing fluid 38 may flow between and around each particle of expanded filter particles 18. Flow around expanded filter particles 18 may cause any accumulated contamination particles to become suspended in the fluid. The suspension of contamination particles in the washing fluid may cause the fluid to become a waste fluid. Waste fluid 40, flows out of filter chamber 20 through perforated wall 16, and out of tank 12 through washing outlet 36. When in a backwashing configuration, filtering inlet 14 is closed. Waste fluid 40 from washing outlet 36 may be conducted to a waste fluid reservoir.

Removal of contamination particles from filter particles 18 by washing fluid 38 may be facilitated by the composition of filter particles 18. The substantially smooth, homogeneous surface of filter particles 18, without fibers or strands, may prevent absorption, adsorption, or adhesion of contamination particles in or to, or to the surfaces of, filter particles 18. The absence of absorption, adsorption, or adhesion may facilitate removal of the contamination particles. In addition, the surfaces of filter particles 18 may optionally be coated with, or the particles themselves may be made of, a material that repels a fluid or contamination particle.

It should be clear that the description of the embodiments and attached Figures set forth in this specification serves only for a better understanding of the invention, without limiting its scope.

It should also be clear that a person skilled in the art, after reading the present specification could make adjustments or amendments to the attached Figures and above described embodiments that would still be covered by the present invention.

1. A filter comprising a filter chamber of adjustable volume, the filter chamber enclosing a compactable filter medium through which fluid to be filtered may flow, the filter medium comprising a plurality of filter particles, a particle of said plurality of filter particles having an initial shape, being deformable upon application of a deforming force and being capable of substantially regaining its initial shape upon removal of the deforming force, the porosity of the filter medium being adjustable by adjusting the volume of the filter chamber so as to obtain a desired porosity of the filter medium.

2. A filter as claimed in claim 1, wherein a particle of said plurality of filter particles comprises a thermosetic polymer.

3. A filter as claimed in claim 1, wherein a particle of said plurality of filter particles comprises a homogeneous outer surface.

4. A filter as claimed in claim 1, wherein a particle of said plurality of filter particles comprises a material selected from the group of materials consisting of natural rubber, synthetic rubber, plastic, fluoroelastomer and silicone.

5. A filter as claimed in claim 1, wherein the shape of a particle of said plurality of filter particles is selected from the group of shapes consisting of: spherical, spheroid, cylindrical, polyhedral, convex-polyhedral or concave-polyhedral.

6. A filter as claimed in claim 1, wherein a particle of said plurality of filter particles comprises a material that repels the fluid or contamination particles therein.

7. A filter as claimed in claim 1, wherein the filter medium comprises cascaded layers.

8. A filter as claimed in claim 1, wherein the chamber comprises two openings, one opening serving as a flow inlet and one opening serving as a flow outlet.

9. A filter as claimed in claim 8, wherein an opening of said two openings comprises a perforated wall.

10. A filter as claimed in claim 1, wherein the diameter of a particle of said plurality of filter particles is in the range of 0.5 mm to 30 mm.

11. A filter as claimed in claim 1, wherein the diameter of a particle of said plurality of filter particles is in the range of 1 mm to 10 mm.

12. A filter as claimed in claim 1, wherein the hardness of a particle of said plurality of filter particles is in the range of 20 to 80 according to the “A” scale of Shore hardness test

13. A filtering method comprising:
providing a filter that includes a filter chamber of adjustable volume, the filter chamber enclosing a compactable filter medium through which fluid to be filtered may flow, the filter medium comprising a plurality of filter particles, a particle of said plurality of filter particles having an initial shape, being deformable upon application of a deforming force and being capable of substantially regaining its initial shape upon removal of the deforming force;
obtaining a desired porosity of the filter medium being by adjusting the volume of the filter chamber so as to obtain a desired porosity of the filter medium; and
causing a fluid to be filtered to flow through the filter medium.

14. A method as claimed in claim 13, comprising:
expanding the volume of the filter chamber so that said particle of said plurality of particles regains its initial shape; and
causing a washing fluid to flow through the filter medium and remove contamination particles from the filter medium.

15. A method as claimed in claim 14, wherein the step of causing a washing fluid to flow through the filter medium includes causing the washing fluid to flow in a direction that is opposite to the flow direction during filtering.
